(19) United States
(12) Patent Application Publication
(10) Pub. No.: US 2025/0321818 A1
(43) Pub. Date: Oct. 16, 2025

(54) SYSTEM AND METHOD FOR DEFECT ROOT CAUSE DETERMINATION AND REPORTING

(71) Applicant: The Toronto-Dominion Bank, Toronto (CA)

(72) Inventors: Zeeshan FAROOQ, Milton (CA); Sudhish PATHUPPILLIATH, Oakville (CA)

(21) Appl. No.: 18/634,043

(22) Filed: Apr. 12, 2024

(51) Int. Cl. G06F 11/07; G06F 16/22

(52) U.S. Cl. CPC G06F 11/0766; G06F 11/079; G06F 16/2237

(57) ABSTRACT

Computing platforms, methods, and storage media for determining a root cause of a logged defect in a software environment are disclosed. Exemplary implementations may: obtain, by the apparatus, a defect record associated with the logged defect; convert the categorical-format defect record data to numerical-format defect record data suitable for use by a machine learning model; generate, using the machine learning model, numerical-format model prediction data based on the numerical-format defect record data; convert the numerical-format model prediction data to categorical-format defect root cause data comprising categorical data; and generate a defect root cause report based on the defect root cause data and on the categorical-format defect record data.

### FIELD

The present disclosure relates to computing environments, including but not limited to computing platforms, methods, and storage media for determining a root cause of a logged defect in a software environment.

### BACKGROUND

Development and implementation of software may be performed in the context of a software development life cycle (SDLC). As part of the SDLC, defects may be logged that require investigation or triage. Defect logging may be performed using a tool, such as Jira.

According to known approaches, one or more defects may be logged in Jira as part of the SDLC, and the defects may be reviewed by a person. The review of the defects often has as a goal to identify a root cause of the defect. Such root cause analysis may happen late in the process, and the outcome of the analysis may differ from person to person. There may also be inconsistent data between similar and duplicate defects.

Improvements in approaches for determining a root cause of a logged defect in a software environment are desirable.

### BRIEF DESCRIPTION OF THE DRAWINGS

Embodiments of the present disclosure will now be described, by way of example only, with reference to the attached Figures.

FIG. 1 illustrates a system configured for determining a root cause of a logged defect in a software environment, in accordance with one or more embodiments.

FIG. 2 illustrates another system configured for determining a root cause of a logged defect in a software environment, in accordance with one or more embodiments.

FIG. 3 illustrates a method for determining a root cause of a logged defect in a software environment, in accordance with one or more embodiments.

FIG. 4 illustrates a first graphical representation relating to ML model features of one or more embodiments.

FIG. 5 illustrates a second graphical representation relating to ML model features of one or more embodiments.

FIG. 6 illustrates an example of a final report output, according to one or more embodiments.

FIG. 7 illustrates an example of predicted cause counters and referenced components, according to one or more embodiments.

### DETAILED DESCRIPTION

Computing platforms, methods, and storage media for determining a root cause of a logged defect in a software environment are disclosed. Exemplary implementations may: obtain, by the apparatus, a defect record associated with the logged defect; convert the categorical-format defect record data to numerical-format defect record data suitable for use by a machine learning model; generate, using the machine learning model, numerical-format model prediction data based on the numerical-format defect record data; convert the numerical-format model prediction data to categorical-format defect root cause data comprising categorical data; and generate a defect root cause report based on the defect root cause data and on the categorical-format defect record data.

The present disclosure provides a platform for automated prediction of a root cause of a logged defect, using machine learning.

Embodiments of the present disclosure provide a system for performing a root cause analysis related to defects logged within a software development cycle, whether at the production level or support level. Typically, a defect is logged into Jira. According to known approaches, after a lot of time spent, a person may be able to determine the root cause of the defect. Embodiments of the present disclosure use a machine learning model to predict the root cause whenever a defect is logged. In an implementation, historical data is used to train and build the ML model, and current data from the defect report is used to predict the root cause.

One aspect of the present disclosure relates to a computing platform configured for determining a root cause of a logged defect in a software environment. The computing platform may include a non-transient computer-readable storage medium having executable instructions embodied thereon. The computing platform may include one or more hardware processors configured to execute the instructions. The processor(s) may execute the instructions to obtain, by the apparatus, a defect record associated with the logged defect. The defect record may include categorical-format current defect record data. The processor(s) may execute the instructions to convert the categorical-format defect record data to numerical-format defect record data suitable for use by a machine learning model. The processor(s) may execute the instructions to generate, using the machine learning model, numerical-format model prediction data based on the numerical-format defect record data. The processor(s) may execute the instructions to convert the numerical-format model prediction data to categorical-format defect root cause data including categorical data. The processor(s) may execute the instructions to generate a defect root cause report based on the defect root cause data and on the categorical-format defect record data.

Another aspect of the present disclosure relates to a method for determining a root cause of a logged defect in a software environment. The method may include obtaining, by the apparatus, a defect record associated with the logged defect. The defect record may include categorical-format current defect record data. The method may include converting the categorical-format defect record data to numerical-format defect record data suitable for use by a machine learning model. The method may include generating, using the machine learning model, numerical-format model prediction data based on the numerical-format defect record data. The method may include converting the numerical-format model prediction data to categorical-format defect root cause data including categorical data. The method may include generating a defect root cause report based on the defect root cause data and on the categorical-format defect record data.

Yet another aspect of the present disclosure relates to a non-transient computer-readable storage medium having instructions embodied thereon, the instructions being executable by one or more processors to perform a method for determining a root cause of a logged defect in a software environment. The method may include obtaining, by the apparatus, a defect record associated with the logged defect. The defect record may include categorical-format current defect record data. The method may include converting the categorical-format defect record data to numerical-format defect record data suitable for use by a machine learning model. The method may include generating, using the machine learning model, numerical-format model prediction data based on the numerical-format defect record data. The method may include converting the numerical-format model prediction data to categorical-format defect root cause data including categorical data. The method may include generating a defect root cause report based on the defect root cause data and on the categorical-format defect record data.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

According to known approaches, root cause and impacted components are not identified when a defect is logged and requires investigation and triage. Application problematic areas are typically identified late in SDLC cycle.

There is a technical problem associated with known approaches in that there is no automated way to identify impacted components when a defect is logged. Embodiments of the present disclosure solve this problem by obtaining, by a processor or apparatus, a defect record associating with a logged defect, where the defect record may comprise a defect identification, as well as impacted components, and doing so early in the SDLC cycle.

Root cause analysis (RCA) happens late in the process, and the outcome may differ from person to person. There can also be inconsistent data between similar and duplicate defects. Embodiments of the present disclosure solve this problem by automatically performing, using a standard processor-implemented process, a root cause prediction and generation, providing the data earlier in the process and removing inconsistency introduced by human interpretation.

There is a technical problem associated with known approaches in that there is no automated way to review logged defects and analyze the logged defects to perform a root cause analysis. Embodiments of the present disclosure solve this problem by providing a machine learning model that can be used by a processor or apparatus to perform an automated review of logged defects, and to analyze the logged defects to perform a root cause analysis.

There is another technical problem associated with ML models in that ML models require data to be in numeric form, which does not provide an output that is useful for human review. Embodiments of the present disclosure solve this technical problem by using a processor or apparatus to convert data in a first format from the defect log into a numeric form for processing in the ML model. After the numeric data has been processed by the ML model and an ML model data output has been generated, embodiments of the present disclosure also convert the ML model data output in numeric form to a form understood by a human, for example a form that associates a known set of possible root causes with the numeric data produced by the ML model.

There is a further technical problem associated with known approaches in that there is no automated and repeatable way to generate a root cause analysis determination for one defect, let alone a plurality of defects. Embodiments of the present disclosure solve this problem by automatically generating, by a processor or apparatus, a defect root cause report based on the defect root cause data and on the categorical-format defect record data, each of which may be associated with a plurality of defects. Embodiments of the present disclosure may also solve this problem by causing, by a processor or apparatus, display of the generated defect root cause report, or one or more portions thereof, where the report may be based on root cause determinations or predictions for a plurality of logged defects. Embodiments of the present disclosure may also solve this problem by displaying the generated defect root cause report, or one or more portions thereof.

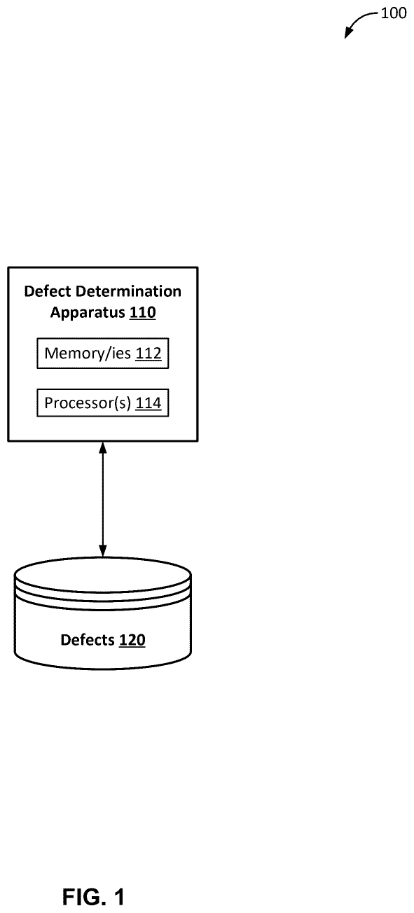

FIG. 1 illustrates a system 100 configured for determining a root cause of a logged defect in a software environment, in accordance with one or more embodiments. The system may include a defect determination apparatus 110, and a defect database 120. The apparatus 110 may include one or more memory/ies 112 having executable instructions embodied thereon. The memory/ies 112 may comprise one or more non-transient computer-readable storage media. The computing platform may include one or more hardware processors 114 configured to execute the instructions.

The processor(s) 114 may execute the instructions to obtain, by the apparatus 100, a defect record associated with the logged defect. The logged defect may comprise a defect for which defect data has been logged in a defect logging system or software. The defect record may be obtained from the defect database 120. The defect record may include categorical-format current defect record data, for example data in a format based on identifying a category of defect, such as a plain language word or phrase. The defect record may comprise a defect identification, which may be a unique identifier, as well as an identification of impacted components, representing components impacted by the identified defect. The defect record may be based on defect data logged in a defect logging system or software. In an embodiment, the processor(s) 114 may obtain defect data and generate the defect record based on logged defect data.

The processor(s) 114 may execute the instructions to convert the categorical-format defect record data to numerical-format defect record data suitable for use by a machine learning model. The numerical-format defect record data may be a numerical representation, translation or other conversion of the categorical-format defect record data, for example converting a plain language word or phrase understood by a user to a number usable by a machine learning model. The processor(s) 114 may execute the instructions to generate, using the machine learning model, numerical-format model prediction data based on the numerical-format defect record data. The numerical-format model prediction data may comprise a prediction of a root cause associated with the logged defect, where the prediction is determined or calculated by the machine learning model, to augment or supplement the data provided in the defect record. The processor(s) 114 may execute the instructions to convert the numerical-format model prediction data to categorical-format defect root cause data including categorical data. The processor(s) 114 may execute the instructions to generate a defect root cause report based on the defect root cause data and on the categorical-format defect record data.

The processor(s) 114 may execute the instructions to cause, by the processor, display of the generated defect root cause report, or one or more portions thereof where the report may be based on root cause determinations or predictions for a plurality of logged defects. The processor(s) 114 may execute the instructions to display the generated defect root cause report, or one or more portions thereof, for example on a display device associated with or in communication with the processor(s) 114.

According to one or more embodiments, the system 100 or apparatus 110 may comprise or be configured to execute a classification machine learning (ML) model which is configured to consume historical data, such as from JTMF and Jira for predictions. JTMF has some testing capabilities on top of Jira, but is not sufficient to help determine the root cause of a defect. A tool according to one or more embodiments allows a software development team to focus on problematic areas and perform early impact assessment as per prediction results.

According to one or more embodiments, the system 100 is configured to extract data from Jira and JTMF, and to convert categorical data to a format understood by the machine learning model. Model prediction data may be transformed to categorical data for reporting purposes. Custom features, a data map and a numbering system may be created to convert and transform the input and output data. In accordance with one or more embodiments, the system 100 is configured to employ a supervised ML technique for data labelling, where some labels are automatically created based on historical data.

When a defect is logged, the system 100 may be configured to predict the root cause, for example using a machine learning model. In an implementation, the system 100 may run against a defect log overnight, and generate a predicted root cause for each of a plurality of logged defects in the defect log.

In an implementation, the system 100 may be configured to pull data from Jira or a similar source/product, such as the defect database 120, and to extract data with defects based on historical data. The system 100 may pull all words and information into numerical data understood by an ML model. The system 100 may convert everything that is understood by ML model.

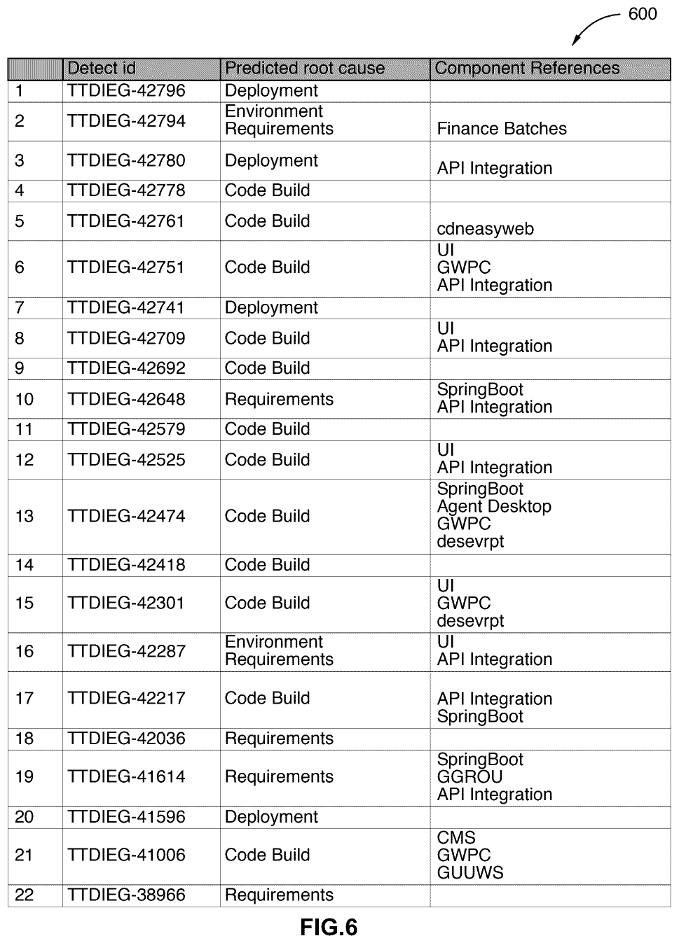

In an example implementation, defect data that the system 100 reads may be assigned a numerical value. The root cause reported by the system 100, for example in a generated root cause report based on the machine learning model, may be a word value, or categorical-format defect record data, such as Deployment, Code Build, Requirements, etc. The input data set may be all numerics, or numerical-format defect record data, after conversion. This may be read in a format with summary information from Jira. The data may be converted to numerical form, then reconverted at the end by an ML model. An output result of such steps may be a table as described later in relation to FIG. 6. A target value generated by a machine learning model of the system 100 may be determined to be a “root cause” response. The system 100 may convert back target values to categorical data for report/presentation purposes.

The system 100 may be configured to use historical data to train and build the ML model. The system 100 may be configured to use current data from the defect report, such as from the defect database 120, to predict the root cause. In an implementation, the current data may also be used to improve and re-train the ML model.

Defect data, such as from the defect database 120, is typically provided using categorical values. An ML model needs to use numerical data. Embodiments of the present invention are configured to convert categorical values into numerical data, in a way that is suited for the numerical data.

The system 100 may be configured to perform unsupervised learning automatically. In an implementation, other values that cannot be processed automatically may be output or displayed for further review/assessment. A point of differentiation of the system 100 and associated ML model is in the novelty of the data being input to the system and model, and the use of the ML model in performing related functions.

The system 100 may be configured to perform a process or method for root cause identification for a defect according to one or more embodiments. The system 100 may comprise a machine learning model including features such as linear regression. Such a model may be provided by, or on, a platform such as TensorFlow™, or a similar platform for machine learning. To predict an identified feature, the system 100 may be configured to pull and store defect records into an SQL lite database. In an embodiment, the defect database 120 may be the database into which the defect records are pulled and stored. In another embodiment, the defect database 120 may be a source from which the defect records are obtained. Using a word dictionary, the system 100 may be configured to eliminate common spoken words and store remaining words in a table with auto-generated labels and categorize them with a stored value. If the value is Null in the database, then the system 100 may be configured to auto create records, identify the feature and wait for supervised labelling of newly created data.

Defect data may be processed by the apparatus 110, for example using java code. The system 100 may extract supervised and unsupervised generated labels and create a vector record for each unique word in the comments or description fields, while extracting components and other data. The vector record values may be stored in the database 120, or another database.

In an example embodiment, vector data may get exported by the system 100 into a comma separated variable (CSV) file, then consumed by a machine learning model with linear activation for model generation and prediction. The predicted data may then be transformed into categorical data from vector data by reversing the processes used to convert it to vector values. The system 100 may be configured to generate a final report that summarizes predicted label and referenced components. The final report, or one or more portions thereof, may be generated, then output or displayed.

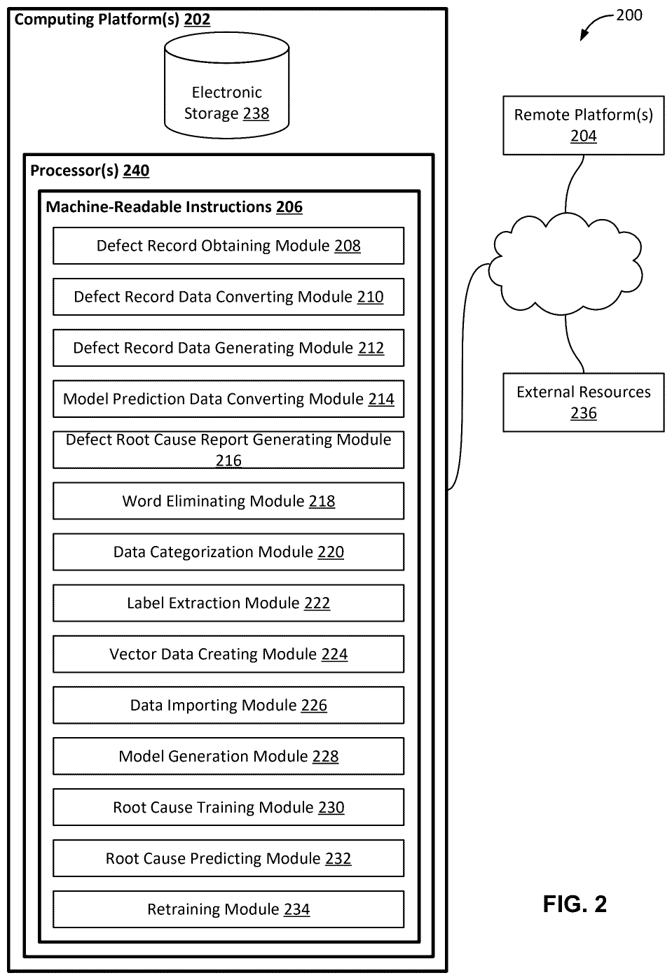

FIG. 2 illustrates a system 200 configured for determining a root cause of a logged defect in a software environment, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of defect record obtaining module 208, defect record data converting module 210, defect record data generating module 212, model prediction data converting module 214, defect root cause report generating module 216, word eliminating module 218, data categorization module 220, label extraction module 222, vector record module 224, data importing module 226, model generation module 228, root cause training module 230, root cause predicting module 232, retraining module 234, and/or other instruction modules.

Defect record obtaining module 208 may be configured to obtain, by the apparatus, a defect record associated with the logged defect. Obtaining the defect record associated with the logged defect may include obtaining, prior to generating the prediction data, an identification of software components impacted by the logged defect. The defect record may include categorical-format current defect record data.

Defect record data converting module 210 may be configured to convert the categorical-format defect record data to numerical-format defect record data suitable for use by a machine learning model. The machine learning model may include a classification machine learning model configured to consume historical data. By way of non-limiting example, generating, using the machine learning model, the prediction data may further include predicting one or more of components, environments or patterns associated with the root cause.

Defect record data generating module 212 may be configured to generate, using the machine learning model, numerical-format model prediction data based on the numerical-format defect record data.

Model prediction data converting module 214 may be configured to convert the numerical-format model prediction data to categorical-format defect root cause data including categorical data.

Defect root cause report generating module 216 may be configured to generate a defect root cause report based on the defect root cause data and on the categorical-format defect record data. Generating the defect root cause report may include generating a report summarizing predicted label and referenced components. By way of non-limiting example, generating the defect root cause report may include generating a report including one or more of a predicted root cause associated with a defect identifier, component references associated with the defect identifier, and a predicted root cause.

The system 200, via defect root cause report generating module 216 or another module, may cause, by the processor(s) 240, display of the generated defect root cause report, or one or more portions thereof, where the report may be based on root cause determinations or predictions for a plurality of logged defects. The system 200, via defect root cause report generating module 216 or another module, may be configured to display the generated defect root cause report, or one or more portions thereof, for example on a display device associated with or in communication with the processor(s) 240.

Word eliminating module 218 may be configured to eliminate common spoken words from the defect record and store remaining data in a table with automatically generated labels.

Data categorization module 220 may be configured to categorize the remaining data with auto generated labels with a stored value.

Label extraction module 222 may be configured to extract supervised and unsupervised generated labels.

Vector data creating module 224 may be configured to create a vector record for each unique word in comments or description fields of the logged defect while extracting components and other data. The vector record values may be stored in a database. The system may be configured to translate predicted data to categorical values used to create vector records. The system may round predicted values to the nearest whole number for RCA mapping. In an example implementation, rounding may be half up by default. If a predicted value is in between the floor and the celling, then the system may return both the floor and celling value. Components referenced in defect, comments and description may be refenced in reports.

Data importing module 226 may be configured to import the vector data into a CSV file.

Model generation module 228 may be configured to consume the CSV file, for example by a machine learning model with linear activation for model generation and prediction. The predicted data may then be transformed into categorial data from vector data by the reverse of the process used to convert to vector values.

Root cause training module 230 may be configured to train the machine learning model using historical defect data and root cause data.

Root cause predicting module 232 may be configured to predict the root cause and generate the defect root cause data report based on the current defect record data. Root cause predicting module 232 may be configured to cause display of the defect root cause data report, or one or more portions thereof.

Retraining module 234 may be configured to retrain the machine learning model using the current defect record data.

In some embodiments, computing platform(s) 202, remote platform(s) 204, and/or external resources 236 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 236 may be operatively linked via some other communication media.

A given remote platform 204 may include one or more processors configured to execute computer program modules. The computer program modules may be configured to enable an expert or user associated with the given remote platform 204 to interface with system 200 and/or external resources 236, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 236 may include sources of information outside of system 200, external entities participating with system 200, and/or other resources. In some embodiments, some or all of the functionality attributed herein to external resources 236 may be provided by resources included in system 200.

Computing platform(s) 202 may include electronic storage 238, one or more processors 240, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 238 may comprise non-transitory storage media that electronically stores information. The electronic storage media of electronic storage 238 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 238 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 238 may include one or more virtual storage resources (e.g., cloud storage, a virtual private network, and/or other virtual storage resources). Electronic storage 238 may store software algorithms, information determined by processor(s) 240, information received from computing platform(s) 202, information received from remote platform(s) 204, and/or other information that enables computing platform(s) 202 to function as described herein.

Processor(s) 240 may be configured to provide information processing capabilities in computing platform(s) 202. As such, processor(s) 240 may include one or more of a digital processor, an analog processor, a digital circuit designed to process information, an analog circuit designed to process information, a state machine, and/or other mechanisms for electronically processing information. Although processor(s) 240 is shown in FIG. 2 as a single entity, this is for illustrative purposes only. In some embodiments, processor(s) 240 may include a plurality of processing units. These processing units may be physically located within the same device, or processor(s) 240 may represent processing functionality of a plurality of devices operating in coordination. Processor(s) 240 may be configured to execute modules 208, 210, 212, 214, 216, 218, 220, 222, 224, 226, 228, 230, 232, and/or 234, and/or other modules. Processor(s) 240 may be configured to execute modules 208, 210, 212, 214, 216, 218, 220, 222, 224, 226, 228, 230, 232, and/or 234, and/or other modules by software; hardware; firmware; some combination of software, hardware, and/or firmware; and/or other mechanisms for configuring processing capabilities on processor(s) 240. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, 226, 228, 230, 232, and/or 234 are illustrated in FIG. 2 as being implemented within a single processing unit, in embodiments in which processor(s) 240 includes multiple processing units, one or more of modules 208, 210, 212, 214, 216, 218, 220, 222, 224, 226, 228, 230, 232, and/or 234 may be implemented remotely from the other modules. The description of the functionality provided by the different modules 208, 210, 212, 214, 216, 218, 220, 222, 224, 226, 228, 230, 232, and/or 234 described below is for illustrative purposes, and is not intended to be limiting, as any of modules 208, 210, 212, 214, 216, 218, 220, 222, 224, 226, 228, 230, 232, and/or 234 may provide more or less functionality than is described. For example, one or more of modules 208, 210, 212, 214, 216, 218, 220, 222, 224, 226, 228, 230, 232, and/or 234 may be eliminated, and some or all of its functionality may be provided by other ones of modules 208, 210, 212, 214, 216, 218, 220, 222, 224, 226, 228, 230, 232, and/or 234. As another example, processor(s) 240 may be configured to execute one or more additional modules that may perform some or all of the functionality attributed below to one of modules 208, 210, 212, 214, 216, 218, 220, 222, 224, 226, 228, 230, 232, and/or 234.

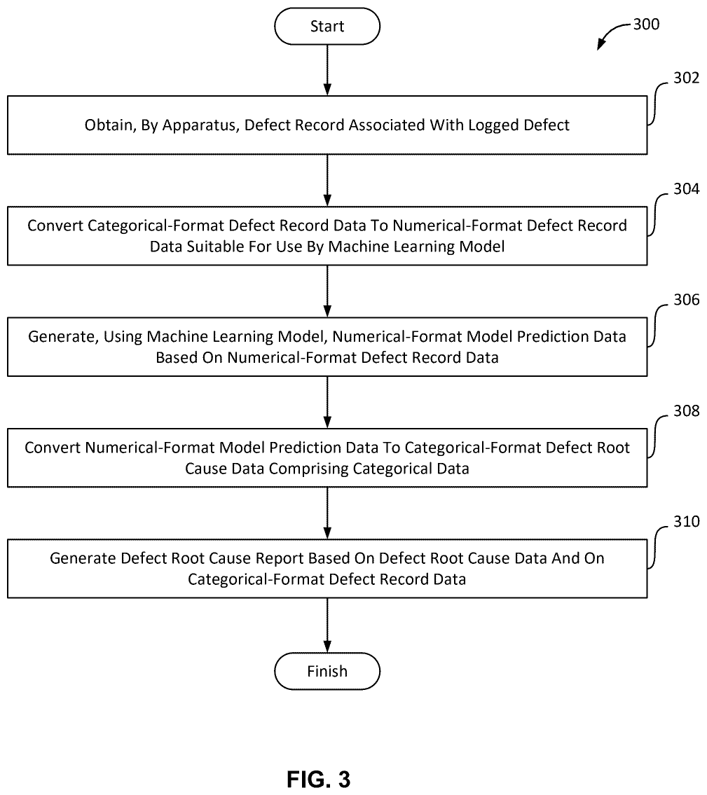

FIG. 3 illustrates a method 300 for determining a root cause of a logged defect in a software environment, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, by the apparatus, a defect record associated with the logged defect. The defect record may include categorical-format current defect record data. Operation 302 may be performed by one or more hardware processors configured by machine-readable instructions including a module that is the same as or similar to defect record obtaining module 208, in accordance with one or more embodiments.

An operation 304 may include converting the categorical-format defect record data to numerical-format defect record data suitable for use by a machine learning model. Operation 304 may be performed by one or more hardware processors configured by machine-readable instructions including a module that is the same as or similar to defect record data converting module 210, in accordance with one or more embodiments.

An operation 306 may include generating, using the machine learning model, numerical-format model prediction data based on the numerical-format defect record data. Operation 306 may be performed by one or more hardware processors configured by machine-readable instructions including a module that is the same as or similar to defect record data generating module 212, in accordance with one or more embodiments.

An operation 308 may include converting the numerical-format model prediction data to categorical-format defect root cause data including categorical data. Operation 308 may be performed by one or more hardware processors configured by machine-readable instructions including a module that is the same as or similar to model prediction data converting module 214, in accordance with one or more embodiments.

An operation 310 may include generating a defect root cause report based on the defect root cause data and on the categorical-format defect record data. Operation 310 may be performed by one or more hardware processors configured by machine-readable instructions including a module that is the same as or similar to defect root cause report generating module 216, in accordance with one or more embodiments.

The method may include a further operation of causing display of the generated defect root cause report, or one or more portions thereof, where the report may be based on root cause determinations or predictions for a plurality of logged defects. The method may include a further operation of displaying the generated defect root cause report, or one or more portions thereof, for example on a display device associated with or in communication with the system. These further operations may be performed by one or more hardware processors configured by machine-readable instructions including a module configured to cause display or to display the generated defect root cause report, or one or more portions thereof.

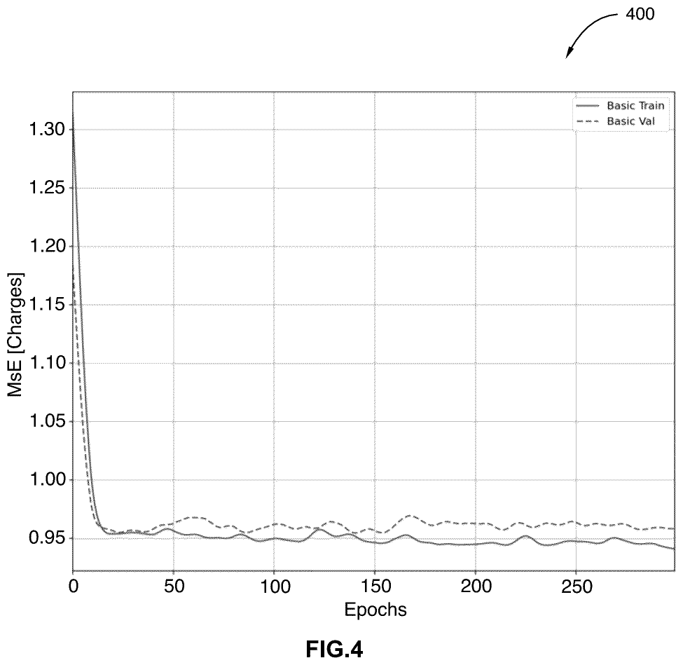

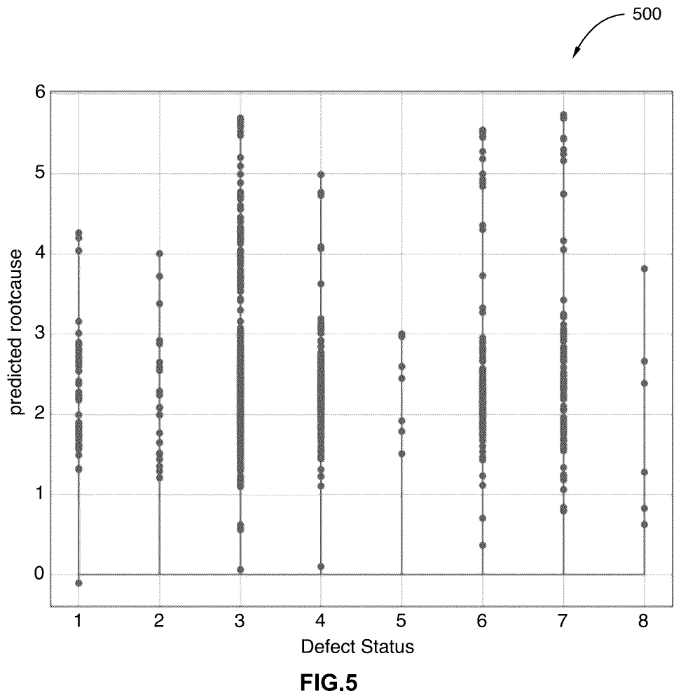

FIG. 4 and FIG. 5 illustrate first and second graphical representations 400 and 500 relating to ML model features of one or more embodiments. Using a system according to one or more embodiments, defects with a missing root cause were assigned 0.0 and transformed into non categorical values, an example of which is shown in FIG. 4. In an example embodiment using an ML convolutional neural network (CNN) model, the system successfully predicted root cause between 1-6 as per historical data, as shown in FIG. 5. The model may be used to predict other missing elements such as components, environment and other patterns. Existing defect RCA and root cause may be extracted for model training.

FIG. 6 illustrates an example of a final report output 600, according to one or more embodiments. The final report output 600 may be generated based on defect root cause data and on categorical-format defect record data which is based on model prediction data generated by a machine learning model, as described above. The final report output 600 may include a defect ID, providing a unique identification of each logged defect. The final report output 600 may include a predicted root cause associated with the defect ID, as well as component references associated with the defect ID and the predicted root cause. For example, as shown in FIG. 6, defect number 16 has a defect ID of TTDIEG-42287, and a predicted root cause of Environment Requirements as generated by the system and the machine learning model. Defect number 16 also has component references of UI and API Integration, meaning that those two components are impacted by defect number 16. The final report output 600 may comprise a plurality of logged defects, each of the plurality of logged defects including a predicted root cause and one or more component references identifying impacted components.

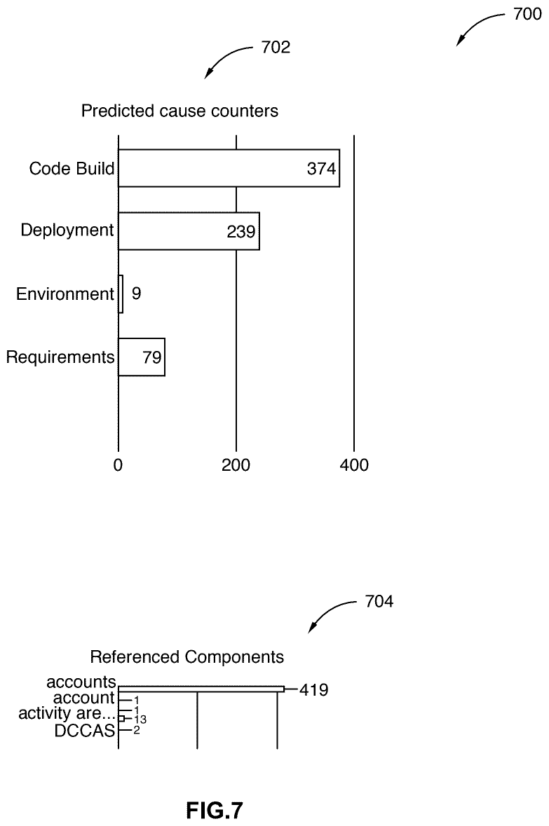

FIG. 7 illustrates an example graphical output 700 showing predicted cause counters and referenced components, according to one or more embodiments. While the final report output 600 in FIG. 6 is designed to provide granular data in a generated output, the graphical output 700 in FIG. 7 is designed to provide more of an overview of the distribution of different predicted root causes and referenced components. The graphical output 700 may comprise a predicted root cause visualization 702, providing a visual representation of a proportion, tally or count of predicted root causes.

A system according to one or more embodiments is configured not only to automatically generate root cause data for a plurality of logged defects, but also to automatically generate a visual representation, for example of a plurality of generated root cause determinations or predicted root causes. This solves a technical problem associated with known approaches, according to which root cause data cannot be automatically generated by a system or processor, let alone caused to be displayed, since root cause data is determined in known approaches by a person based on the person's professional skill upon review of relevant data. This also solves a further technical problem associated with known approaches, where it is not possible or reasonable to obtain and centrally store human-determined root cause data from a plurality of operators. A system according to one or more embodiments is configured to solve this problem by automatically generating a visual display of, or associated with, a plurality of generated root cause determinations associated with a plurality of logged defects.

The graphical output 700 may comprise a referenced component visualization 704, providing a visual representation of a proportion, tally or count of referenced components. A system of one or more embodiments may be configured to cause display of one or both of the components of the graphical output 700. One or both of the components of the graphical output 700 may be displayed at a display associated with the system of one or more embodiments.

A system according to one or more embodiments is configured not only to automatically generate root cause data for a plurality of logged defects, but also to automatically generate a visual representation, for example of a plurality of generated root cause determinations or predicted root causes and/or of a count or proportion of predicted root causes, and/or referenced components. This solves a technical problem associated with known approaches, according to which root cause data, root cause counts or proportions and referenced component data cannot be automatically generated by a system or processor, let alone caused to be displayed, since such data is determined in known approaches by a person based on the person's professional skill upon review of relevant data, if it is determined at all. This also solves a further technical problem associated with known approaches, where it is not possible or reasonable to obtain and centrally store human-determined root cause data from a plurality of operators. A system according to one or more embodiments is configured to solve this problem by automatically generating a visual display of, or associated with, a plurality of generated root cause determinations associated with a plurality of logged defects and/or of a count or proportion of predicted root causes, and/or referenced components.

In accordance with one or more embodiments, the present disclosure provides a platform for automated prediction of a root cause of a logged defect, using machine learning. Embodiments of the present disclosure use a machine learning model to predict the root cause whenever a defect is logged, and are configured to do so for a plurality of logged defects. In an implementation, historical data is used to train and build the ML model, and current data from the defect report is used to predict the root cause.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the CLAIMS appended hereto.

Embodiments of the disclosure can be described with reference to the following clauses, with specific features laid out in the dependent clauses:

One aspect of the present disclosure relates to a system configured for determining a root cause of a logged defect in a software environment. The system may include one or more hardware processors configured by machine-readable instructions. The processor(s) may be configured to obtain, by the apparatus, a defect record associated with the logged defect. The defect record may include categorical-format current defect record data. The processor(s) may be configured to convert the categorical-format defect record data to numerical-format defect record data suitable for use by a machine learning model. The processor(s) may be configured to generate, using the machine learning model, numerical-format model prediction data based on the numerical-format defect record data. The processor(s) may be configured to convert the numerical-format model prediction data to categorical-format defect root cause data including categorical data. The processor(s) may be configured to generate a defect root cause report based on the defect root cause data and on the categorical-format defect record data.

In some implementations of the system, the processor(s) may be configured to eliminate common spoken words from the defect record and store remaining data in a table with auto generated labels. In some implementations of the system, the processor(s) may be configured to categorize the remaining data with auto generated labels with a stored value.

In some implementations of the system, the processor(s) may be configured to extract supervised and unsupervised generated labels. In some implementations of the system, the processor(s) may be configured to create a vector record for each unique word in comments or description fields of the logged defect while extracting components and other data. In some implementations of the system, the vector record values stored in a database.

In some implementations of the system, the processor(s) may be configured to import the vector data into a CSV file. In some implementations of the system, the processor(s) may be configured to consume the CSV file by a machine learning model with linear activation for model generation and prediction. In some implementations of the system, the predicted data then transformed into categorial data from vector data by may reverse the process used to convert to vector values.

In some implementations of the system, the processor(s) may be configured to train the machine learning model using historical defect data and root cause data. In some implementations of the system, the processor(s) may be configured to predict the root cause and generating the defect root cause data report based on the current defect record data.

In some implementations of the system, the processor(s) may be configured to retrain the machine learning model using the current defect record data.

In some implementations of the system, obtaining the defect record associated with the logged defect may include obtaining, prior to generating the prediction data, an identification of software components impacted by the logged defect.

In some implementations of the system, the machine learning model may include a classification machine learning model configured to consume historical data.

In some implementations of the system, generating, using the machine learning model, the prediction data may further include predicting one or more of components, environments or patterns associated with the root cause.

In some implementations of the system, generating the defect root cause report may include generating a report summarizing predicted label and referenced components.

In some implementations of the system, generating the defect root cause report may include generating a report including one or more of a predicted root cause associated with a defect identifier, component references associated with the defect identifier, and a predicted root cause.

Another aspect of the present disclosure relates to a method for determining a root cause of a logged defect in a software environment. The method may include obtaining, by the apparatus, a defect record associated with the logged defect. The defect record may include categorical-format current defect record data. The method may include converting the categorical-format defect record data to numerical-format defect record data suitable for use by a machine learning model. The method may include generating, using the machine learning model, numerical-format model prediction data based on the numerical-format defect record data. The method may include converting the numerical-format model prediction data to categorical-format defect root cause data including categorical data. The method may include generating a defect root cause report based on the defect root cause data and on the categorical-format defect record data.

In some implementations of the method, it may include eliminating common spoken words from the defect record and store remaining data in a table with auto generated labels. In some implementations of the method, it may include categorizing the remaining data with auto generated labels with a stored value.

In some implementations of the method, it may include extracting supervised and unsupervised generated labels. In some implementations of the method, it may include creating a vector record for each unique word in comments or description fields of the logged defect while extracting components and other data. In some implementations of the method, the vector record values stored in a database.

In some implementations of the method, it may include importing the vector data into a CSV file. In some implementations of the method, it may include consuming the CSV file by a machine learning model with linear activation for model generation and prediction. In some implementations of the method, the predicted data then transformed into categorial data from vector data by may reverse the process used to convert to vector values.

In some implementations of the method, it may include training the machine learning model using historical defect data and root cause data. In some implementations of the method, it may include predicting the root cause and generating the defect root cause data report based on the current defect record data.

In some implementations of the method, it may include retraining the machine learning model using the current defect record data.

In some implementations of the method, obtaining the defect record associated with the logged defect may include obtaining, prior to generating the prediction data, an identification of software components impacted by the logged defect.

In some implementations of the method, the machine learning model may include a classification machine learning model configured to consume historical data.

In some implementations of the method, generating, using the machine learning model, the prediction data may further include predicting one or more of components, environments or patterns associated with the root cause.

In some implementations of the method, generating the defect root cause report may include generating a report summarizing predicted label and referenced components.

In some implementations of the method, generating the defect root cause report may include generating a report including one or more of a predicted root cause associated with a defect identifier, component references associated with the defect identifier, and a predicted root cause.

Yet another aspect of the present disclosure relates to a non-transient computer-readable storage medium having instructions embodied thereon, the instructions being executable by one or more processors to perform a method for determining a root cause of a logged defect in a software environment. The method may include obtaining, by the apparatus, a defect record associated with the logged defect. The defect record may include categorical-format current defect record data. The method may include converting the categorical-format defect record data to numerical-format defect record data suitable for use by a machine learning model. The method may include generating, using the machine learning model, numerical-format model prediction data based on the numerical-format defect record data. The method may include converting the numerical-format model prediction data to categorical-format defect root cause data including categorical data. The method may include generating a defect root cause report based on the defect root cause data and on the categorical-format defect record data.

In some implementations of the computer-readable storage medium, the method may include eliminating common spoken words from the defect record and store remaining data in a table with auto generated labels. In some implementations of the computer-readable storage medium, the method may include categorizing the remaining data with auto generated labels with a stored value.

In some implementations of the computer-readable storage medium, the method may include extracting supervised and unsupervised generated labels. In some implementations of the computer-readable storage medium, the method may include creating a vector record for each unique word in comments or description fields of the logged defect while extracting components and other data. In some implementations of the computer-readable storage medium, the vector record values stored in a database.

In some implementations of the computer-readable storage medium, the method may include importing the vector data into a CSV file. In some implementations of the computer-readable storage medium, the method may include consuming the CSV file by a machine learning model with linear activation for model generation and prediction. In some implementations of the computer-readable storage medium, the predicted data then transformed into categorial data from vector data by may reverse the process used to convert to vector values.

In some implementations of the computer-readable storage medium, the method may include training the machine learning model using historical defect data and root cause data. In some implementations of the computer-readable storage medium, the method may include predicting the root cause and generating the defect root cause data report based on the current defect record data.

In some implementations of the computer-readable storage medium, the method may include retraining the machine learning model using the current defect record data.

In some implementations of the computer-readable storage medium, obtaining the defect record associated with the logged defect may include obtaining, prior to generating the prediction data, an identification of software components impacted by the logged defect.

In some implementations of the computer-readable storage medium, the machine learning model may include a classification machine learning model configured to consume historical data.

In some implementations of the computer-readable storage medium, generating, using the machine learning model, the prediction data may further include predicting one or more of components, environments or patterns associated with the root cause.

In some implementations of the computer-readable storage medium, generating the defect root cause report may include generating a report summarizing predicted label and referenced components.

In some implementations of the computer-readable storage medium, generating the defect root cause report may include generating a report including one or more of a predicted root cause associated with a defect identifier, component references associated with the defect identifier, and a predicted root cause.

Still another aspect of the present disclosure relates to a system configured for determining a root cause of a logged defect in a software environment. The system may include means for obtaining, by the apparatus, a defect record associated with the logged defect. The defect record may include categorical-format current defect record data. The system may include means for converting the categorical-format defect record data to numerical-format defect record data suitable for use by a machine learning model. The system may include means for generating, using the machine learning model, numerical-format model prediction data based on the numerical-format defect record data. The system may include means for converting the numerical-format model prediction data to categorical-format defect root cause data including categorical data. The system may include means for generating a defect root cause report based on the defect root cause data and on the categorical-format defect record data.

In some implementations of the system, the system may include means for eliminating common spoken words from the defect record and store remaining data in a table with auto generated labels. In some implementations of the system, the system may include means for categorizing the remaining data with auto generated labels with a stored value.

In some implementations of the system, the system may include means for extracting supervised and unsupervised generated labels. In some implementations of the system, the system may include means for creating a vector record for each unique word in comments or description fields of the logged defect while extracting components and other data. In some implementations of the system, the vector record values stored in a database.

In some implementations of the system, the system may include means for importing the vector data into a CSV file. In some implementations of the system, the system may include means for consuming the CSV file by a machine learning model with linear activation for model generation and prediction. In some implementations of the system, the predicted data then transformed into categorial data from vector data by may reverse the process used to convert to vector values.

In some implementations of the system, the system may include means for training the machine learning model using historical defect data and root cause data. In some implementations of the system, the system may include means for predicting the root cause and generating the defect root cause data report based on the current defect record data.

In some implementations of the system, the system may include means for retraining the machine learning model using the current defect record data.

In some implementations of the system, obtaining the defect record associated with the logged defect may include obtaining, prior to generating the prediction data, an identification of software components impacted by the logged defect.

In some implementations of the system, the machine learning model may include a classification machine learning model configured to consume historical data.

In some implementations of the system, generating, using the machine learning model, the prediction data may further include predicting one or more of components, environments or patterns associated with the root cause.

In some implementations of the system, generating the defect root cause report may include generating a report summarizing predicted label and referenced components.

In some implementations of the system, generating the defect root cause report may include generating a report including one or more of a predicted root cause associated with a defect identifier, component references associated with the defect identifier, and a predicted root cause.

Even another aspect of the present disclosure relates to a computing platform configured for determining a root cause of a logged defect in a software environment. The computing platform may include a non-transient computer-readable storage medium having executable instructions embodied thereon. The computing platform may include one or more hardware processors configured to execute the instructions. The processor(s) may execute the instructions to obtain, by the apparatus, a defect record associated with the logged defect. The defect record may include categorical-format current defect record data. The processor(s) may execute the instructions to convert the categorical-format defect record data to numerical-format defect record data suitable for use by a machine learning model. The processor(s) may execute the instructions to generate, using the machine learning model, numerical-format model prediction data based on the numerical-format defect record data. The processor(s) may execute the instructions to convert the numerical-format model prediction data to categorical-format defect root cause data including categorical data. The processor(s) may execute the instructions to generate a defect root cause report based on the defect root cause data and on the categorical-format defect record data.

In some implementations of the computing platform, the processor(s) may execute the instructions to eliminate common spoken words from the defect record and store remaining data in a table with auto generated labels. In some implementations of the computing platform, the processor(s) may execute the instructions to categorize the remaining data with auto generated labels with a stored value.

In some implementations of the computing platform, the processor(s) may execute the instructions to extract supervised and unsupervised generated labels. In some implementations of the computing platform, the processor(s) may execute the instructions to create a vector record for each unique word in comments or description fields of the logged defect while extracting components and other data. In some implementations of the computing platform, the vector record values stored in a database.

In some implementations of the computing platform, the processor(s) may execute the instructions to import the vector data into a CSV file. In some implementations of the computing platform, the processor(s) may execute the instructions to consume the CSV file by a machine learning model with linear activation for model generation and prediction. In some implementations of the computing platform, the predicted data then transformed into categorial data from vector data by may reverse the process used to convert to vector values.

In some implementations of the computing platform, the processor(s) may execute the instructions to train the machine learning model using historical defect data and root cause data. In some implementations of the computing platform, the processor(s) may execute the instructions to predict the root cause and generating the defect root cause data report based on the current defect record data.

In some implementations of the computing platform, the processor(s) may execute the instructions to retrain the machine learning model using the current defect record data.

In some implementations of the computing platform, obtaining the defect record associated with the logged defect may include obtaining, prior to generating the prediction data, an identification of software components impacted by the logged defect.

In some implementations of the computing platform, the machine learning model may include a classification machine learning model configured to consume historical data.

In some implementations of the computing platform, generating, using the machine learning model, the prediction data may further include predicting one or more of components, environments or patterns associated with the root cause.

In some implementations of the computing platform, generating the defect root cause report may include generating a report summarizing predicted label and referenced components.

In some implementations of the computing platform, generating the defect root cause report may include generating a report including one or more of a predicted root cause associated with a defect identifier, component references associated with the defect identifier, and a predicted root cause.

What is claimed is:

1. An apparatus configured for of determining a root cause of a logged defect in a software environment, the apparatus comprising:
a non-transient computer-readable storage medium having executable instructions embodied thereon; and
one or more hardware processors configured to execute the instructions to:
obtain, by the apparatus, a defect record associated with the logged defect, the defect record comprising categorical-format current defect record data;
convert the categorical-format defect record data to numerical-format defect record data suitable for use by a machine learning model;
generate, using the machine learning model, numerical-format model prediction data based on the numerical-format defect record data;
convert the numerical-format model prediction data to categorical-format defect root cause data comprising categorical data; and
generate a defect root cause report based on the defect root cause data and on the categorical-format defect record data.

2. The apparatus of claim 1 wherein the one or more hardware processors are further configured to execute the instructions to:
eliminate common spoken words from the defect record and store remaining data in a table with auto generated labels; and
categorize the remaining data with auto generated labels with a stored value.

3. The apparatus of claim 1 wherein the one or more hardware processors are further configured to execute the instructions to:
extract supervised and unsupervised generated labels;
create a vector record for each unique word in comments or description fields of the logged defect while extracting components and other data, the vector record values stored in a database.

4. The apparatus of claim 1 wherein the one or more hardware processors are further configured to execute the instructions to:
import the vector data into a CSV file;
consume the CSV file by a machine learning model with linear activation for model generation and prediction, the predicted data then transformed into categorial data from vector data by reversing the process used to convert to vector values.

5. The apparatus of claim 1 wherein the one or more hardware processors are further configured to execute the instructions to:
train the machine learning model using historical defect data and root cause data; and
predict the root cause and generating the defect root cause data report based on the current defect record data.

6. The apparatus of claim 5 wherein the one or more hardware processors are further configured to execute the instructions to:
retrain the machine learning model using the current defect record data.

7. The apparatus of claim 1 wherein the one or more hardware processors are further configured to execute the instructions to:
obtain, prior to generating the prediction data, an identification of software components impacted by the logged defect.

8. The apparatus of claim 1 wherein the one or more hardware processors are further configured to execute the instructions to:
predict, using the machine learning model, one or more of components, environments or patterns associated with the root cause.

9. The apparatus of claim 1 wherein the one or more hardware processors are further configured to execute the instructions to:
generate the defect root cause report including one or more of a predicted root cause associated with a defect identifier, component references associated with the defect identifier, and a predicted root cause.

10. A processor-implemented method of determining a root cause of a logged defect in a software environment, the method comprising:
obtaining a defect record associated with the logged defect, the defect record comprising categorical-format current defect record data;
converting the categorical-format defect record data to numerical-format defect record data suitable for use by a machine learning model;
generating, using the machine learning model, numerical-format model prediction data based on the numerical-format defect record data;
converting the numerical-format model prediction data to categorical-format defect root cause data comprising categorical data; and
generating a defect root cause report based on the defect root cause data and on the categorical-format defect record data.

11. The method of claim 10 further comprising:
eliminating common spoken words from the defect record and store remaining data in a table with auto generated labels; and
categorizing the remaining data with auto generated labels with a stored value.

12. The method of claim 10 further comprising:
extracting supervised and unsupervised generated labels;
creating a vector record for each unique word in comments or description fields of the logged defect while extracting components and other data, the vector record values stored in a database.

13. The method of claim 10 further comprising:
importing the vector data into a CSV file;
consuming the CSV file by a machine learning model with linear activation for model generation and prediction, the predicted data then transformed into categorial data from vector data by reversing the process used to convert to vector values.

14. The method of claim 10 further comprising:
training the machine learning model using historical defect data and root cause data; and
predicting the root cause and generating the defect root cause data report based on the current defect record data.

15. The method of claim 14 further comprising:
retraining the machine learning model using the current defect record data.

16. The method of claim 10 wherein obtaining the defect record associated with the logged defect comprises obtaining, prior to generating the prediction data, an identification of software components impacted by the logged defect.

17. The method of claim 10 wherein generating, using the machine learning model, the prediction data further comprises predicting one or more of components, environments or patterns associated with the root cause.

18. The method of claim 10 wherein generating the defect root cause report comprises generating a report including one or more of a predicted root cause associated with a defect identifier, component references associated with the defect identifier, and a predicted root cause.

19. A non-transient computer-readable storage medium having instructions embodied thereon, the instructions being executable by one or more processors to perform a method of determining a root cause of a logged defect in a software environment, the method comprising:
obtaining a defect record associated with the logged defect, the defect record comprising categorical-format current defect record data;
converting the categorical-format defect record data to numerical-format defect record data suitable for use by a machine learning model;
generating, using the machine learning model, numerical-format model prediction data based on the numerical-format defect record data;
converting the numerical-format model prediction data to categorical-format defect root cause data comprising categorical data; and
generating a defect root cause report based on the defect root cause data and on the categorical-format defect record data.

20. The non-transient computer-readable storage medium of claim 19 wherein the method further comprises:
training the machine learning model using historical defect data and root cause data; and
predicting the root cause and generating the defect root cause data report based on the current defect record data.
